(19) United States
(12) Patent Application Publication
(10) Pub. No.: US 2011/0248471 A1
(43) Pub. Date: Oct. 13, 2011

(54) Wheelchair With Seat Lift Mechanism

(76) Inventor: Gary C. Springer, Andover, MN (US)

(21) Appl. No.: 12/759,090

(22) Filed: Apr. 13, 2010

(51) Int. Cl. A61G 5/10; A61G 5/00

(52) U.S. Cl. 280/304.1

(57) ABSTRACT

To assist disabled persons that cannot get from the floor into a wheelchair without assistance or other lift devices, the wheelchair is provided with a translatable carriage on which the wheelchair seat is mounted. A DC motor is arranged to drive a lead screw that engages a travelling nut secured to the carriage to lower the seat to floor level where a paraplegic can leave and re-enter upon the wheelchair seat. Accessible controls allow the occupant to be able to operate the motor from the seat when at floor level so as to be raised to a normal chair seating height.

### BACKGROUND OF THE INVENTION

I. Field of the Invention

This invention relates generally to wheelchairs and more particularly to a custom wheelchair having a seat that can be moved between a position in contact with the ground and an elevated, seating position.

II. Discussion of the Prior Art

Spinal cord injuries or congenital defects may result in paraplegia where the person loses motor and sensory function in his/her lower extremities. Mobility for such persons is often provided by wheelchairs. There are many styles of wheelchairs available on the market today including manually powered chairs, motorized chairs, chairs that allow the person to partake in various sports, all of which are often customized to meet special physical needs, to improve or provide special performance and to otherwise express the user's individuality. Thus, a wheelchair can be much more than a vehicle to get one from point A to point B.

The present invention is directed to a wheelchair improvement that can provide a paraplegic with greater self-sufficiency. For example, while it is practically impossible for an individual confined to a wheelchair to be able to dress and undress without the aid of a care person, such daily routines can be accomplished if the paraplegic individual has a way to exit the chair to a sitting position on the floor with his/her legs extended. It is far easier to dress a patient on a hard flat surface than on a bed, thus the floor is the choice of many paraplegics and their caregivers.

This device is also very beneficial for healthcare workers. Whenever a patient is on the floor, he/she can be slid into the chair in the lowered position and be raised with little effort. From the raised position, he/she can be transferred onto a bed or other destination without the caregiver lifting him/her. Thus, the wheelchair of the present invention eliminates or limits the need for caregivers to physically lift patients.

An occupant may also lower the seat to reach items on the floor or lower shelves. This helps prevent the user from the potential of falling out when attempting such maneuvers. The seat height is adjustable to better fit various height counters and tables. This adjustment feature is also handy when using various air and gel seat cushions which vary in height.

Thus, the present invention fulfills a need for a customized wheelchair capable of slowly lowering an individual to the floor and for subsequently lifting that individual back to a sitting position in a wheelchair.

Other than the lift mechanism, the chair of the present invention is to be used as a normal, manual wheelchair.

### SUMMARY OF THE INVENTION

The customized wheelchair of the present invention comprises a frame assembly supported at a front end by a pair of relatively small diameter caster wheels and at a rear end by a pair of relatively large diameter manually rotatable wheels. The frame further includes a lower transversely extending horizontal brace and an upper transversely extending horizontal brace with a pair of side rails connected between the two at opposed ends thereof. An elongated, vertically oriented lead screw is journaled for rotation in bearings affixed to the lower brace approximately midway along the length of those braces. An electric motor is affixed to the lower brace and is coupled in driving relation to the lead screw. The wheelchair also includes a carriage assembly having a cross member with a traveling nut threaded on the lead screw and a pair of spaced-apart side members affixed to opposed end portions of the cross member, where the side members each have cam rollers affixed thereto for engaging each of the pair of frame side rails. A seat is mounted on the carriage assembly and is movable with the carriage assembly between a ground-engaging position and a desired height above the ground position.

The motor is preferably a DC battery driven motor and connected in circuit with it is a control switch which when actuated by a person seated in the wheelchair will drive the lead screw to thereby slowly lower the seat to aground-engaging position. To insure that the front caster wheels will not be in the path of travel of the seat as it descends, sensing switches are provided that prevent the motor from lowering the seat if the caster wheels are not aligned with the frame. Also, a limit switch is located on the frame to shut off current to the motor when the ground-engaging position is reached. Likewise, actuation of the control switch when the seat is in the ground-engaging position will cause the lead screw to rotate in an opposite direction, thereby raising the seat back to a normal sitting height. Again, a second limit switch mounted on the frame and engageable by the moving carriage will cause the current to the motor to be interrupted when the seat reaches its fully elevated disposition.

### DESCRIPTION OF THE DRAWINGS

The foregoing features, objects and advantages of the invention will be apparent to those skilled in the art from the following detailed description of a preferred embodiment, especially when considered in conjunction with the accompanying drawings in which:

FIG. 1 is a left side view of a wheelchair incorporating the seat lift mechanism of the present invention;

FIG. 2 is a rear view of the wheelchair;

FIG. 3 is a right side view of a preferred embodiment; and

FIG. 4 is a top view thereof.

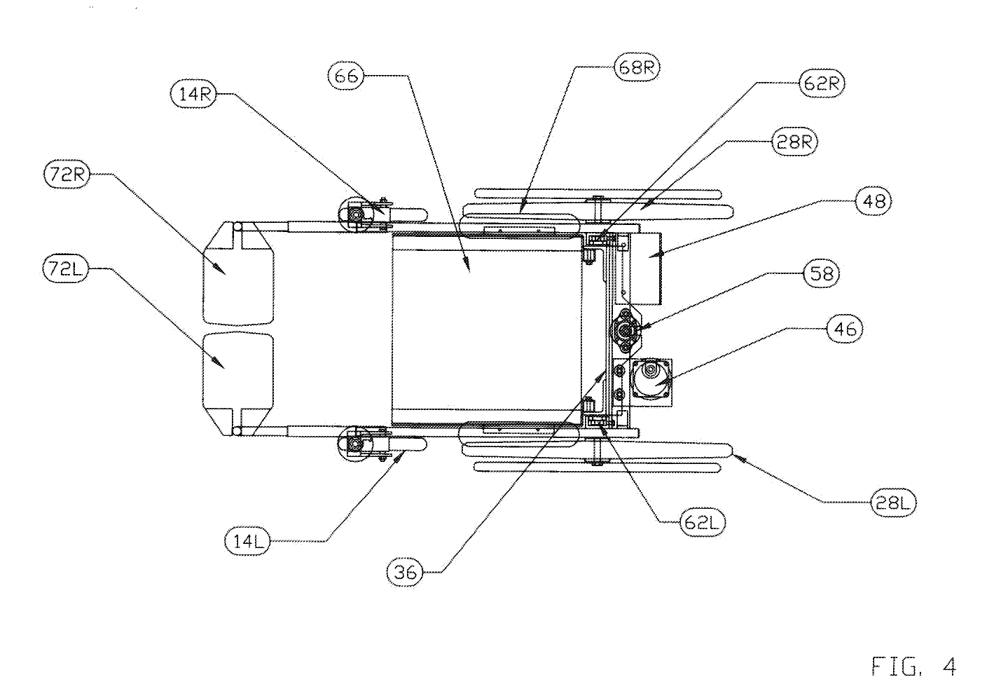

### DESCRIPTION OF A PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

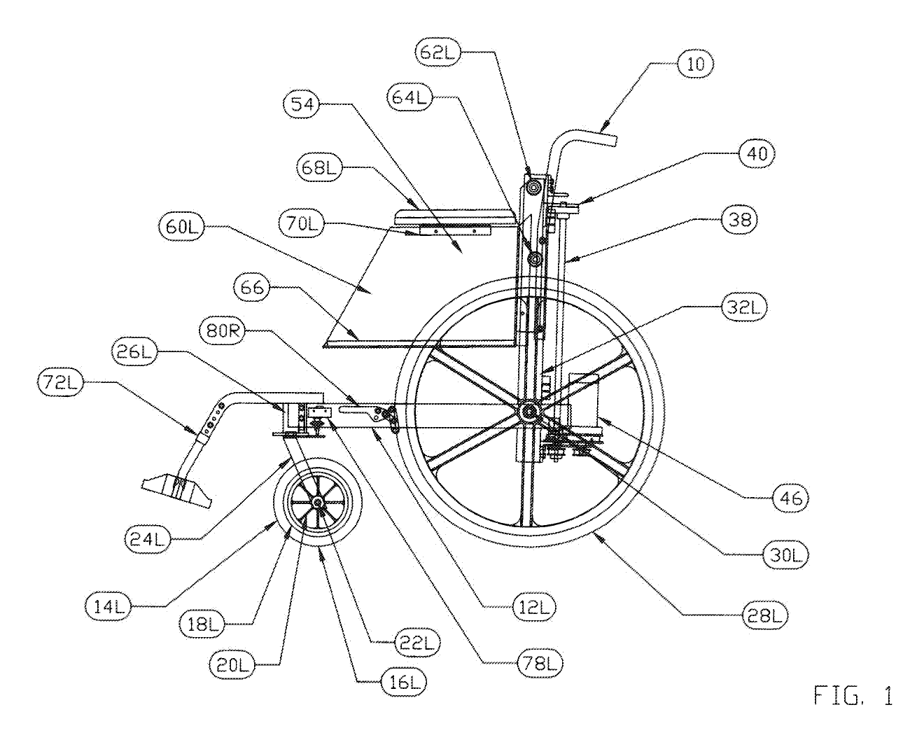

Referring to FIG. 1, there is indicated generally by numeral 10 a wheelchair comprising an exemplary embodiment of the present invention. It comprises a frame 12L comprising an aluminum extrusion supported proximate its front end by a caster wheel 14L including a rubber tire 16L on a rim 18L connected by spokes to a hub 20L. The hub 20L mounts on an axle 22L journaled for rotation on an arm 24L that is pivotally joined to the frame members 12L by a bracket 26L. Located proximate the rear end of the frame member 12L is a wheel of relatively large diameter 28L that is arranged to be manually rotatable about a stub axle 30L projecting out from the frame. Extending perpendicularly upward from the horizontal frame member 12L is a side rail 32L.

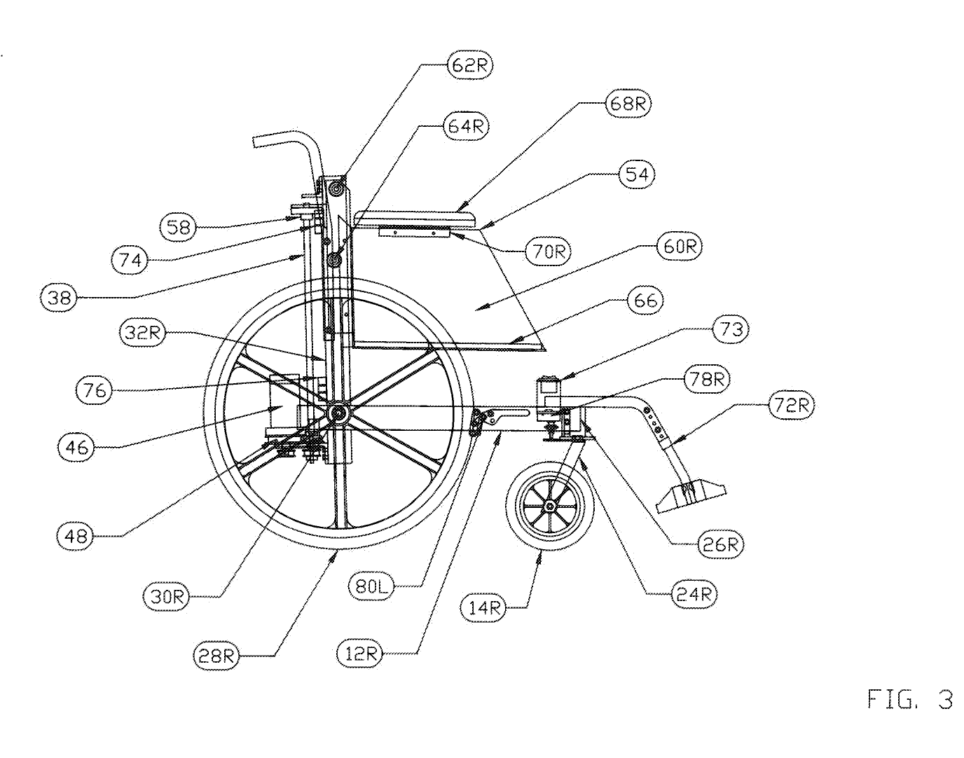

Turning momentarily to FIG. 3, there is shown a right side view of the wheelchair. It shows a right side horizontal frame member 12R supported at its front end by a caster wheel 14R that is identical to the caster wheel assembly 14L. The rearmost end of the horizontal frame member 12R is supported by a relatively large diameter manually rotatable wheel 28R that is journaled for rotation on a stub axle 30R. The frame assembly further includes aside rail 32R that is affixed to the horizontal frame member 12R and extends vertically upward therefrom.

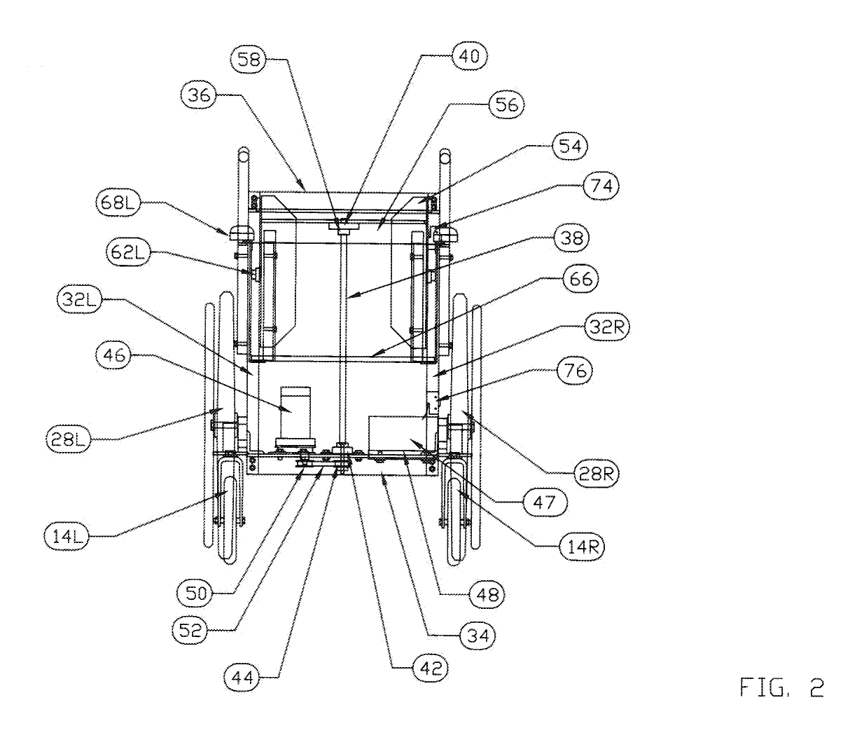

Referring next to the rear view of FIG. 2, it can be seen that the frame further includes a lower, transversely extending, horizontal brace 34 that connects at opposed ends to the lower end of the side rails 32L and 32R. Likewise, extending transversely between the upper end portions of the side rails 32L and 32R is an upper brace 36.

An elongated, vertically oriented lead screw 38 is journaled for rotation on the lower brace 34 proximate a midpoint of those braces by virtue of a traveling nut mount 40 and a bearing 42. The view of FIG. 2 also shows that the lower end of the lead screw extends downward through the brace 34 and has a pulley 44 affixed to its lower end. Also mounted on the lower horizontal brace 34 is an electric motor 46 that is adapted to be driven by a DC battery (not shown) that is designed to be supported on a battery tray 48 also affixed to the lower brace 34. The shaft of the motor extends through the horizontal leg of the brace 34 and secured to it is a pulley 50 such that the motor 46 drives the lead screw 38 using a notched timing belt 52. It is also contemplated that a chain and sprocket drive can also be used.

A vertically slidable carriage assembly indicated generally by numeral 54 is joined to the frame. More particularly, and as best seen in FIG. 2, the carriage assembly 54 includes a cross member 56 having a traveling nut 58 threaded onto the elongated lead screw 38. FIGS. 1 and 3 show suspended from the cross member 56 at opposite ends thereof are side members 60L and 60R. Cam rollers as at 62L, 62R, 64L and 64R are affixed to the side members 60L and 60R and those cam rollers engage each of the pair of frame side rails 32L and 32R.

Completing the carriage assembly is a seat member 66 that attaches between the lower ends of the side members 60L and 60R. Disposed atop the side members 60L and 60R are folding armrests 68L and 68R. The armrests 68L and 68R are joined to the side members by hinges as at 70L and 70R, allowing the armrests to be pivoted inward out of the way when not being used to function as armrests for the patient. In this way, they do not extend the width of the chair unnecessarily. Affixed to the front end portion of the horizontal frame members 12L and 12R are removable footrests 72L and 72R.

In that the traveling nut 58 is affixed to the carriage brace 56, as the motor drives the lead screw 38 in a first direction, the nut will travel down the length of the lead screw thereby lowering the carriage assembly with its seat 66. The cam rollers 62R, 64R, 62L and 64L cooperate with the frame side rails 32R and 32L to prevent the weight of the person from tilting the seat 66 as the carriage assembly moves downward.

Identified by numeral 73 in FIG. 3 is an up/down control switch that is accessible to the user when the seat 66 is in either its raised position illustrated or when the seat is abutting the ground. Affixed to the frame approximate the upper end of the right side rail 32R is a limit switch 74. Similarly, mounted near the bottom end of the frame side rail 32R is a lower limit switch 76. The wiring between the battery and motor are such that when the control switch 73 is held to its down position, the carriage assembly will descend downward until the lower limit switch 76 is actuated to interrupt current flow to the motor. Now, when the control switch 73 is held in its “up” position, the lead screw is made to rotate in an opposite direction causing the carriage assembly and seat 66 to rise to a desired upper level and ultimately to a maximum level established by the placement of the limit switch 74.

To insure that the front caster wheels 14L and 14R do not interfere with the descent of the carriage assembly by being oriented at an angle to the frame members 12L and 12R, safety limit switches 78L and 78R are provided that are closed only when the caster wheels 14L and 14R lie in a plane parallel to the plane of the large diameter wheels 28L and 28R. If the caster wheels are canted at an angle, the safety limit switches 78L and 78R open to interrupt current flow to the motor and the control switch 73 will be unable to override the open switch condition.

Also illustrated in FIGS. 1 and 3 are conventional brake arrangements that when engaged, clamp against the rubber tire of the wheels 28L and 28R to prevent those wheels from rotating. Upon release, the frictional engagement of the brake assemblies is removed and the chair can be moved freely in a conventional fashion. The brake arrangements are identified in FIGS. 1 and 3 by numerals 80L and 80R.

Not shown in the drawings is a covering drape that deploys down the back of the chair to shield the motor and lead screw mechanism from contact. More particularly, a panel of flexible sheet material, such as canvas or vinyl, has one edge fastened by brackets to the rear of the movable seat and its free end weighted and draped over an upper roller. As the seat descends, the covering drape moves down with it as the free end rises up toward but not over the upper roller. When the seat is made to move up, the covering drape also moves up as the weights on the free end maintain the panel taut.

It can be seen, then, that the present invention provides a wheelchair design in which a paraplegic wheelchair occupant can be safely and slowly lowered to the floor where he/she may lay flat with legs extended to remove clothing items and to otherwise change clothes, perhaps with the aid of an elongated grasper where the patient's arms can be used to draw pants, stockings and slipper or loafer-type shoes on. Following those maneuvers, the person can use arm forces to slide back on to the now ground engaging seat and, when so located, can actuate the switch 73 to cause the carriage assembly and seat to rise up on the wheelchair frame until the person is in a normal seated position.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A wheelchair having a powered, vertically movable seat comprising:
a) a frame assembly supported at a front end by a pair of relatively small diameter caster wheels and at a rear end by a pair of relatively large diameter wheels, the frame including a lower, transversely extending horizontal brace and an upper transversely extending horizontal brace and a pair of side rails connected between the lower and upper braces at opposed ends thereof;
b) an elongated, vertically oriented lead screw journaled for rotation on said lower brace proximate a midpoint thereof;
c) an electric motor affixed to the lower brace and coupled in driving relation to the lead screw;
d) a rechargeable battery mounted to the frame for powering the motor;
e) a carriage assembly having a cross member with a traveling nut threaded on the lead screw and a pair of spaced-apart side members affixed to opposed end portions of the cross member where the side members each have cam rollers affixed thereto for engaging each of said pair of side rails;
f) a seat mounted on the carriage assembly and movable with the carriage assembly between a ground engaging position and a selected height above the ground position; and
g) a pair of limit switches mechanically connected to the frame and electrically connected in circuit between the battery and the motor for shutting off the motor when the seat reaches the ground engaging position or a predetermined height above the ground position.

2. (canceled)

3. (canceled)

4. The wheelchair as in claim 1 and further including a manually operable control switch mounted to the frame and coupled in circuit with the battery and motor for selectively energizing the motor.

5. The wheelchair as in claim 1 and further including first and second footrests affixed to said front end of the frame.

6. The wheelchair as in claim 1 and further including a safety limit switch disposed proximate the caster wheels and connected in circuit with the battery and motor for interrupting current flow to the motor when the caster wheels are not oriented parallel to the rear wheels.

7. The wheelchair as claim 1 and further including a pair of armrests affixed to the side members of the carriage assembly.

8. The wheelchair as in claim 7 wherein the pair of armrests is hinged to the side members.

9. The wheelchair as in claim 1 and further including a pair of wheelchair push handles attached to the side rails of the frame assembly.

10. The wheelchair as in claim 1 wherein the motor is connected in driving relation to the screw by either a belt and pulley drive or a chain and sprocket drive.

11. The wheelchair as in claim 1 and further including a horizontal shelf attached to the lower brace for supporting the battery.
